(19) United States
(12) Patent Application Publication
(10) Pub. No.: US 2017/0248065 A1
(43) Pub. Date: Aug. 31, 2017

(54) THERMAL MANAGEMENT SYSTEM AND METHOD OFMAKING AND USING THE SAME

(71) Applicant: BorgWarner Inc., Auburn Hills, MI (US)

(72) Inventors: Xiaobing LIU, Rochester Hlils, MI (US); John SHUTTY, Clarkston, MI (US); KOWALSKE Glenn, Marshall, MI (US)

(21) Appl. No.: 15/503,746

(22) PCT Filed: Aug. 11, 2015
(86) PCT No.: PCT/US2015/044619

§ 371 Date: Feb. 14, 2017

Related U.S. Application Data
(60) Provisional application No. 62/039,075, filed on Aug. 19, 2014.

(51) Int. Cl. F01P 5/12; F01N 5/02; B60H 1/04; F01P 11/08; F01P 7/16; B60H 1/00; F01P 3/20; F02N 19/10

(52) U.S. Cl. CPC F01P 5/12; F01P 3/20; F01N 5/02; F02N 19/10; F01P 11/08; F01P 7/164; B60H 1/00314; B60H 1/00885; B60H 1/04; F01P 2007/146

(57) ABSTRACT

A number of variations may include a thermal management system having an engine and a coolant system comprising a coolant circuit and a coolant pump, wherein the coolant pump is operated by an electronic control unit that operates independently of the engine, and wherein the electronic control unit is constructed and arranged to operate the coolant pump at a higher speed than the engine speed multiplied by pulley ratio during engine warm up.

### CROSS-REFERENCE TO RELATED APPLICATIONS

This application claims the benefit of U.S. Provisional Application No. 62/039,075 filed Aug. 19, 2014.

### TECHNICAL FIELD

The field to which the disclosure generally relates to includes thermal management components in systems.

### BACKGROUND

Thermal management components may be used in a variety of applications including, but not limited to, vehicle engines.

### SUMMARY OF ILLUSTRATIVE VARIATIONS OF THE INVENTION

A number of variations may include a product having a thermal management system comprising: an engine and a coolant system comprising a coolant circuit and a coolant pump wherein the coolant pump is operated by an electronic control unit that operates independently of the engine, and wherein the electronic control unit is constructed and arranged to operate the coolant pump at a higher speed than the engine speed multiplied by pulley ratio during engine warm up. A number of variations may include a method including providing a thermal management system comprising: an engine and a coolant system comprising a coolant circuit and a coolant pump wherein the coolant pump is operated by an electronic control unit that operates independently of the engine, and operating the thermal management system during engine warm up wherein the coolant pump speed is higher than engine speed multiplied by pulley ratio.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 illustrates a thermal management system according to a number of variations.

FIG. 2 illustrates a thermal management system according to a number of variations.

FIG. 3 illustrates a thermal management system according to a number of variations.

### DETAILED DESCRIPTION OF ILLUSTRATIVE VARIATIONS OF THE INVENTION

The following description of the variations is merely illustrative in nature and is in no way intended to limit the invention, its application, or uses.

In a number of variations, a thermal management system may be used to manage heat in a system such as, but not limited to, a vehicle engine. In a number of variations, the thermal management system may include a coolant that is routed through the thermal management system by a pump. In a number of variations, the pump may be a dual-mode coolant pump. In a number of variations, the dual-mode coolant pump may comprise an electric motor or may comprise a mechanical pulley drive or may comprise both. In a number of variations, the electric motor may be a brushless DC (BLDG) electric motor. In a number of variations, the dual-mode coolant pump may be in electrical mode, where the pump may be driven by the electric motor, or may be in mechanical mode, where the pump may be driven by the engine through belts or gears. In a number of variations, the electric motor may be positioned inside a mechanical pulley assembly and may operate based on the power supplied by the engine. In a number of variations, the pump may be adapted to be driven mechanically by the engine belt attached to a crankshaft of the engine. In a number of variations, the pulley assembly may include a clutch housing member and a pulley member wherein the pulley member is driven by a belt. In a number of variations, sensors feed an electronic control unit (ECU) which sends a signal to the pump to determine desired speed using the electric motor or by engaging the clutch housing member and driving the pump from the pulley member. In a number of variations, the electric motor may be able to provide “over-drive” where the pump can be spun at speeds greater than mechanical engine input speed from the engine. In a number of variations, in mechanical mode, the mechanical pump speed may be determined by engine speed multiplied by a pulley ratio. Pulley ratio may be defined as the ratio between the engine crank pulley and the pump pulley member. The pulley ratio may be fixed and could be greater than or less than or equal to 1. Pulley ratio of less than 1 indicates a higher pump speed than engine speed. In a number of variations, the mechanical pulley drive and/or electric motor may operate based on the power supplied independently of the engine. In a number of variations, the pump may be in electrical mode and pump speed may be from about 300 RPM to about 3000 RPM. In a number of variations, when the pump is in electric mode, the pump speed may be independent of engine speed and my able in an “overdrive mode” where the pump speed is higher than mechanical pump speed (i.e. engine speed×pulley ratio). In a number of variations, the dual-mode coolant pump may be operated by an electronic control unit. A non-limiting example of a dual-mode coolant pump may be found in U.S. application Ser. No. 13/473,577.

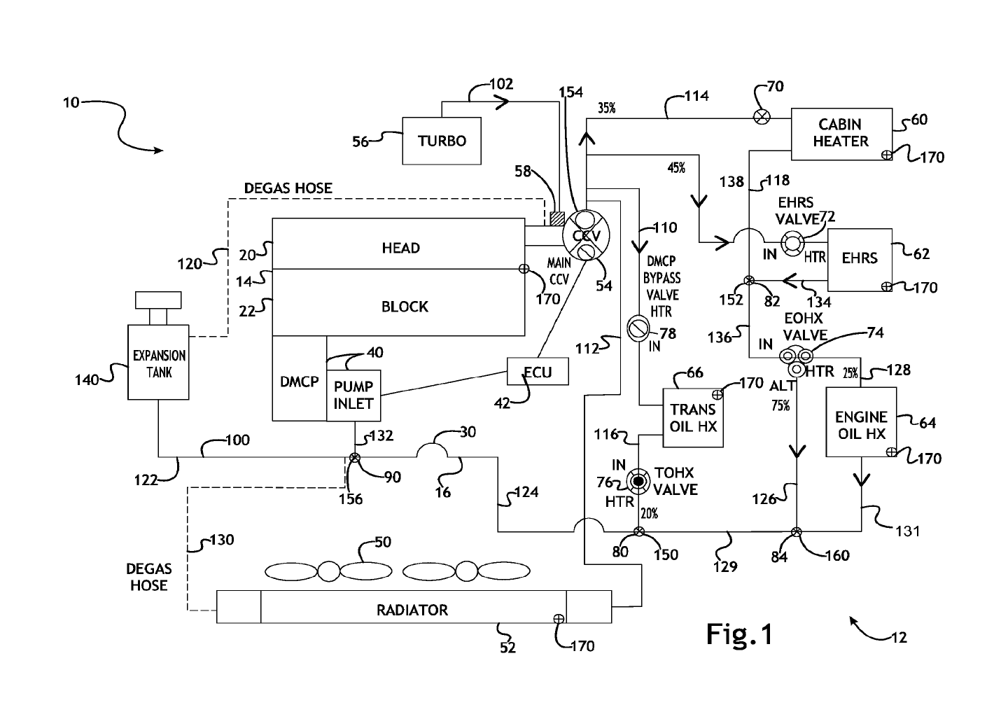

FIG. 1 illustrates a number of variations. In a number of variations, a product 10 is shown. In a number of variations, the product 10 may include a vehicle such as, but not limited to, a motor vehicle, watercraft, spacecraft, aircraft, or may be another type. In a number of variations, the product 10 may include a thermal management system 12. In a number of variations, the thermal management system 12 may include an engine 14. In a number of variations, the engine 14 may be an internal combustion engine, an external combustion engine, an electric motor, a hybrid engine, or may be another type. In a number of variations, the engine 14 may include an engine head 20 and an engine block 22. In a number of variations, the thermal management system 12 may include components such as, but not limited to, a cooling fan 50, a radiator 52, a thermostat 54, a turbocharger 56, an expansion tank 140, a transmission oil heat exchanger 66, an engine oil heat exchanger 64, an exhaust heat recovery system 62, and/or a cabin heater 60. In a number of variations, the thermal management system 12 may include a coolant system 16. A non-limiting example of a exhaust heat recovery system may be found in U.S. Pat. No. 4,911,110. In a number of variations, the coolant system 16 may include a coolant 30. In a number of variations, the coolant 30 may be a fluid and may include, but is not limited to, air, water, oil, antifreeze (such as water and glycol), rust inhibitor, or a combination thereof. In a number of variations, the coolant system 16 may include a circuit 100 to route coolant through various components of the thermal management system 12. In a number of variations, the coolant system 16 may include a pump 40 to circulate the coolant 30 through the coolant system 16. In a number of variations, the pump 40 may have a variable speed (RPM) or variable flowrate of coolant sent through the coolant system 16. In a number of variations, the pump 40 speed may be driven by the engine 14. In a number of variations, the pump 40 speed may be driven independently of the engine 14. In a number of variations, the pump 40 speed may be independently controlled as an electric pump or a dual mode coolant pump (DMCP). In a number of variations, an independent electronic control unit (ECU) 42 may control the flow rate of coolant 30 through the coolant system by controlling pump 40 speed or pump displacement. In a number of variations, the pump speed may be controlled wherein the pump speed is in electrical overdrive mode where the pump speed may be from about 300 RPM to about 3000 RPM. In a number of variations, the pump speed may be independent of engine speed. In a number of variations, the pump speed may be higher than mechanical pump speed (engine speed multiplied by pulley ratio). In a number of variations, the ECU 42 may acquire data from a number of sensors (only sensor 170 shown for clarity) or sources in order to operate and regulate various systems of the thermal management system 12, engine 14, and/or coolant system 16. The sensors can be used to measure temperatures of fluids or components, pressures, speeds (e.g. RPM), and the like. In a number of variations, the ECU 42 may take this data and optimize the thermal management system 12 to minimize fuel usage. In a number of variations, the ECU 42 may be constructed and arranged to allow higher pump 40 speed than engine speed multiply by pulley ratio to allow for higher heat transfer to other thermal management system 12 components or fluids. In a number of variations, the ECU 42 may be constructed and arranged to raise pump speed during engine warm up to allow for higher heat transfer to other thermal management system 12 components or fluids.

As shown in FIG. 1, in a number of variations, coolant 30 may flow through the pump 40 into the engine 14 through the engine block 22 and engine head 20. In a number of variations, the thermal management system 12 may also include a turbocharger 56 that forces air into the engine through line 102. In a number of variations, the turbocharger 56 may include an intercooler 58. In a number of variations, the turbocharger 56 may provide additional heat to the coolant 30 of the coolant system 16. In a number of variations, the coolant system 16 may include a thermostat (and/or main Coolant Control Valve (CCV)) 54 to control coolant flow 30 to various components within the thermal management system 12. In a number of variations, the thermostat 54 may include an additional coolant control valve (CCV) 154 to control coolant flow 30 to various components within the thermal management system 12 when the thermostat is closed. In a number of variations, the thermostat 54 and/or coolant control valve 154 may be controlled by the ECU 42. In a number of variations, the thermostat 54 and/or CCV 154 may allow coolant flow 30 to a cabin heater 60. In a number of variations, the thermostat 54 and/or CCV 154 may allow coolant flow 30 to an exhaust heat recovery system (EHRS) 62. In a number of variations, the thermostat 54 and/or CCV 154 may allow coolant flow 30 to an engine oil heat exchanger 64. In a number of variations, the thermostat 54 and/or CCV 154 may allow coolant flow to a transmission oil heat exchanger 66. A skilled artisan would understand these components and their uses. In a number of variations, the cabin heater 60 may include at least one cabin heater valve 70 to allow or restrict coolant 30 flow to or from this component. In a number of variations, the EHRS 62 may include at least one EHRS valve 72 to allow or restrict coolant 30 flow to or from this component. In a number of variations, the engine oil heat exchanger 64 may include at least one engine oil heat exchanger valve 74 to allow or restrict coolant 30 flow to or from this component. In a number of variations, the transmission oil heat exchanger 66 may include at least one transmission oil heat exchanger valve 76 to allow or restrict coolant 30 flow to or from this component. In a number of variations, coolant 30 flow from the thermostat 54 and/or CCV 154 may allow flow to the cabin heater 60, EHRS 62, engine oil heat exchanger 64 and/or transmission oil heat exchanger 66 at different ratios. In a number of variations the dual mode pump (DMCP) 42 may be mechanically connected to the engine and may have an electric motor (for example, a brushless DC motor) constructed and arranged to supplement the mechanical power provide by the engine or to operate independently of the mechanical link to the engine. The exhaust heat recovery system (EHRS) 62 may include thermal transfer components constructed and arranged to convert thermal losses in the exhaust system into usable energy.

Still referring to FIG. 1, in a number of variations, at engine warm up or normal operation, the coolant pump 42 may circulate coolant 30 through the engine 14, and after circulating through the engine 14, the coolant 30 passes from the engine 14 to the thermostat 54 and CCV 154. When the engine is cold, as during start-up, the thermostat 54 may be closed and the coolant 30 from the engine 14 may be routed through a degas hose 120 to an expansion tank 140 then through a line 122 back to the pump 40 through an intermediate junction 156 (including an intermediate valve 90) and line 132. In a number of variations, the coolant 30 may pass through the intercooler 58 of a turbocharger 56. When the engine 14 and coolant 30 are warmer and/or the engine is in normal operation, the thermostat 54 may open and route the coolant 30 through line 112 to the radiator 54 and back to the pump 40 through line 130 through intermediate junction 156 and line 132. Line 130 may include a degas hose. In a number of variations, the coolant 30 may pass through the intercooler 58 of a turbocharger 56. In a number of variations, the thermostat 54 may be controlled by the amount of heat of the engine 14 or coolant 30. In a number of variations, the thermostat 54 may open when the coolant 30 or engine 14 has a heat range of above 200° C. In a number of variations the coolant 30 may be routed past the closed or open thermostat 54 through the coolant control valve 154 in hot or cold engine 14 conditions where the coolant 30 may pass through the DMCP bypass line 110 including a DMCP bypass valve 78, through a transmission oil heat exchanger 66 and through a transmission oil heat exchanger valve 76 and through line 116. In a number of variations, line 116 may form a primary junction 150 with lines 124 and 126 to route coolant 30 back to the pump 40 through intermediate junction 156 and line 132. In a number of variations, the primary junction 150 may include a primary valve 80. In a number of variations, the coolant 30 may be routed past the closed or open thermostat 54 through the coolant control valve 154 in hot or cold engine 14 conditions where the coolant 30 may pass through a cabin heater line 114 and a cabin heater valve 70 and to a cabin heater 60. In a number of variations, the coolant 30 may be routed past the closed or open thermostat 54 through the coolant control valve 154 in hot or cold engine 14 conditions where the coolant 30 may pass through an exhaust heat recovery system line 138 and an exhaust heat recovery system valve 72 and to an exhaust heat recovery system 62. In a number of variations, the cooler coolant 30 from the cabin heater 60 may pass through a connecting line 118 to an engine oil heat exchanger valve 74. In a number of variations, the warmer coolant 30 leaving the EHRS 62 may be routed through line 134 to combine with the cooler coolant 30 from the cabin heater 60 at a secondary junction 152 which may include a secondary valve 82. In a number of variations, the combined coolant 30 from the secondary junction 152 may be routed through line 136 to an engine oil heat exchanger valve 74. In a number of variations, the engine oil heat exchanger valve 74 may be closed and the coolant 30 may be routed through line 126 through tertiary junction 160 and tertiary valve 84 to line 129 meet coolant 30 from the transmission oil heat exchanger 66 at the primary junction 150, which may include a primary valve 80, and then may be routed back to the pump 40 through line 124, intermediate junction 156, and line 132. In a number of variations, the engine oil heat exchanger valve 74 may be open and the coolant 30 may be routed through line 128 to the engine oil heat exchanger 64 and then the cooled coolant 30 may be routed through line 131 to a tertiary junction 160, which may include a tertiary valve 84. In a number of variations the coolant may then be routed through line 126 to meet coolant from the transmission oil heat exchanger 66 at the primary junction 150, which may include a primary valve 80, and then may be routed back to the pump 40 through line 124, intermediate junction 156, and line 132. In a number of variations, the thermal management system 12 may further include a heat exchanger for axle oil 68, may be included and used to transfer heat to and from the coolant 30 and may further include an axle oil heat exchanger valve 79. In a number of variations, the thermostat 54 and valves 72, 74, 76, 78, 79, 80, 82, 84, and/or 90 may be opened partially and may control differing amounts of coolant 30 through the various components 60, 62, 64, 66, 68, 52, 140. In a number of variations, the valves 72, 74, 76, 78, 79, 80, 82, 84, and/or 90 may be ball valves, butterfly valves, ceramic disc valves, check valves, choke valves, diaphragm valves, gate valves, globe valves, knife valves, needle valves, pinch valves, piston valves, plug valves, poppet valves, spool valves, thermal expansion valves, pressure reducing valves, combinations thereof, or may be another type. In a number of variations, the heat exchangers 66, 64 may be a double pipe, radiator, shell and tube, plate heat, plate and shell, adiabatic wheel, plate fin, pillow plate, fluid heat, dynamic scraped surface, or phase-change heat exchanger, combinations thereof, or may be another type. In a number of variations, all valves 72, 74, 76, 78, 79, 80, 82, 84, and/or 90 may be a proportioning type valve which may allow full, partial, or no flow to the exit lines of the particular valve. In this manner, the change of the flow to and from various components (40, 42, 22, 14, 140, 52, 66, 64, 62, 60, 58, 68, or may be another type) could be over a period of time. In a number of variations, the ECU 42 may control the change of flow of coolant 30 through operation of these valves 72, 74, 76, 78, 79, 80, 82, 84, and/or 90 for optimal engine 14 performance on account of variables include but not limited to, engine temperature, engine pressure, engine performance, vehicle speed, vehicle fuel economy (i.e. MPG), cabin heater heat setting, radiator operation, transmission oil temperature and/or flowrate, engine oil temperature and/or flowrate, axle oil temperature and/or flowrate, exhaust heat recovery system 62 performance, or may be another variable. In a number of variations, the various components (40, 42, 22, 14, 140, 52, 66, 64, 62, 60, 58, 68, or may be another type) could be in parallel or in series.

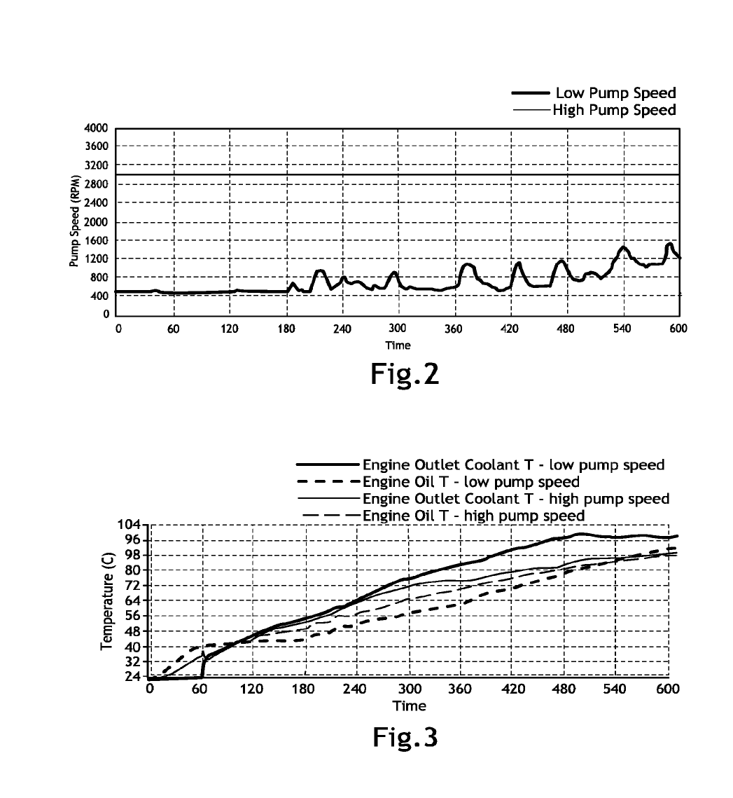

A number of variations may include a method that may include providing a thermal management system 12 comprising: an engine 14 and a coolant system 16 comprising a coolant circuit 100 and a coolant pump 40 wherein the coolant pump 40 may be operated by an electronic control unit 42 that operates independently of the engine 14, and operating the thermal management system 12 during engine 14 warm up wherein the coolant pump 40 speed may be higher than engine 14 speed multiply by pulley ratio. In a number of variations during engine warm up, the pump 40 may having a higher speed during engine 14 warm up to transfer more heat from the coolant 30 to the engine oil. In a number of variation during engine warm up, the pump 40 may having a higher speed during engine 14 warm up to transfer more heat from the coolant 30 to the engine oil at the engine oil heat exchanger 64, to transmission oil at the transmission oil heat exchanger 66, and/or to axle oil in the engine 14, or any combination thereof. In a number of variations, the added speed provides additional heat transfer capability leading to improved fuel economy. In a number of variations, with the engine 14 heating up more quickly, the engine 14 and engine oil may also be heated up more quickly by the coolant 30 which acts to reduce the amount of undesirable exhaust materials to be vented to the atmosphere through the Exhaust Heat Recovery System 62 and an exhaust to the atmosphere. In a number of variations, a faster warm-up of the engine 14 may allow for a catalytic converter (not shown) to be heated up more quickly which may reduce the undesirable materials to be exhausted into the atmosphere. In a number of variations, a faster warm-up of the engine 14 may allow for faster warm up of engine oil and/or transmission oil, and/or axle oil by heat transfer from coolant 30, which may reduce friction and improve fuel economy. In a number of variations, this warm up may be done at the engine oil heat exchanger 64, transmission oil heat exchanger 66, and/or exhaust heat recovery system 62 or another place within the thermal management system 12. In a number of variations, lower engine coolant 30 temperature delays the opening of the thermostat 54 and avoids heat loss through the radiator 52. In a number of variations, the EHRS injects more exhaust heat into the coolant 30 of the thermal management system 12 due to higher pump 40 speed, which allows for effective utilization of engine exhaust heat. In a number of variations, the thermal management system 12 may allow for faster engine 14, transmission, and/or axle warm up, which improves fuel economy. FIG. 2 shows pump speed over time. FIG. 3 shows a comparison of engine outlet coolant temperature and engine oil temperature over time for two configurations. Configuration 1 of when a DMCP is in mechanical mode. Configuration 2 of when a DMCP is in electrical mode with a speed at a constant 3000RPM.

In a number of variations in a cold start process or method, the coolant pump 40 may be kept in an inoperative condition (by the ECU 42) and the engine 14 may be used to heat up the coolant 30 and oil remaining in the engine block 22 where the engine coolant pump 40 may be turned off. When the temperature of the coolant 30 in the engine 13 reaches a desired temperature, such as being sensed by a temperature sensor 170, the coolant pump 40 may be turned on and coolant stored in the radiator 52 and the rest of the thermal management system 12 may be circulated through the pump 40 into the engine 14. In a number of variations during engine start-up as shown in FIG. 1, the ECU 42 will route coolant 30 through the engine 14 and to the cabin heater 60, EHRS 62, and transmission oil heat exchanger 66 at a ratio of about 0.35/0.45/0.3. In a number of variations during engine start-up as shown in FIG. 1, the engine oil heat exchanger valve 74 may route coolant to the engine oil heat exchanger 64 or to bypass the engine oil heat exchanger 64 at a ratio of about 0.25/0.75

In a number of variations, the coolant 30 flow in the thermal management system may be rapidly warmed during start up by warm up of the cabin heater 60, exhaust heat recovery system 62, engine oil heat exchanger 64, and/or transmission oil heat exchanger 66 components or may be a different component. By excluding cold coolant 30 from the engine 14 and radiator 52, the exhaust heat recovery system acts on a smaller volume of coolant allowing faster heating of the components while simultaneously allowing the engine 14 to be warmed internally. In a number of variations, the thermostat 54 may be controlled by the ECU 42 to send coolant 30 to the various components including the cabin heater 60, exhaust heat recovery system 62, engine oil heat exchanger 64, radiator 52, and/or transmission oil heat exchanger 66 components at different ratios for faster engine warm up, maintaining engine temperature, or prevention of engine overheating, depending on the needs and applications of the product 10. In a number of variations, the thermostat 54 may include the coolant control valve 154 as a multi-functional valve. In a number of variations, the ECU 42 may monitor product 10 conditions through sensors to operate the thermostat 54, coolant control valve 154 and/or valves to control the amount of coolant 30 to the various components including the cabin heater 60, exhaust heat recovery system 62, engine oil heat exchanger 64, radiator 52, and/or transmission oil heat exchanger 66 or may be another component, to optimize the product 10 performance.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include product comprising a thermal management system comprising: an engine and a coolant system comprising a coolant circuit and a coolant pump wherein the coolant pump is operated by an electronic control unit that operates independently of the engine, and wherein the electronic control unit is constructed and arranged to operate the coolant pump at a higher speed than the engine speed multiplied by pulley ratio during engine start-up.

Variation 2 may include a product as set forth in Variation 1 wherein the thermal management system further comprises a thermostat and/or a coolant control valve.

Variation 3 may include a product as set forth in any of Variations 1-2 wherein the thermal management system further comprises a cabin heater and wherein the coolant circuit routes coolant through the cabin heater from the engine.

Variation 4 may include a product as set forth in any of Variations 1-3 wherein the thermal management system further comprises a exhaust heat recovery system and wherein the coolant circuit routes coolant through the exhaust heat recovery system from the engine.

Variation 5 may include a product as set forth in any of Variations 1-4 wherein the thermal management system further comprises an engine oil heat exchanger and wherein the coolant circuit routes coolant through the engine oil heat exchanger from the engine.

Variation 6 may include a product as set forth in any of Variations 1-5 wherein the thermal management system further comprises a transmission oil heat exchanger and wherein the coolant circuit routes coolant through the transmission oil heat exchanger from the engine.

Variation 7 may include a product as set forth in any of Variations 1-6 wherein the engine further comprises a turbocharger.

Variation 8 may include a product as set forth in Variations 1-7 wherein the thermal management system further comprises a radiator and wherein the coolant circuit routes coolant through the radiator from the engine when the thermostat is open.

Variation 9 may include a product as set forth in any of Variations 2-8 wherein the ECU controls the thermostat and/or coolant control valve to control coolant circuit outlet flow from the engine.

Variation 10 may include a product as set forth in any of Variations 1-9 wherein the pump is a dual mode coolant pump or electrical pump.

Variation 11 may include a method including providing a thermal management system comprising: an engine and a coolant system comprising a coolant circuit and a coolant pump wherein the coolant pump is operated by an electronic control unit that operates independently of the engine, and operating the thermal management system during engine warm up wherein the coolant pump speed is higher than engine speed multiply by pulley ratio.

Variation 12 may include a method as set forth in Variation 11 wherein the thermal management system further comprises a thermostat and/or a coolant control valve.

Variation 13 may include a method as set forth in any of Variations 11-12 wherein the thermal management system further comprises a cabin heater and wherein the coolant circuit routes coolant through the cabin heater from the engine.

Variation 14 may include a method as set forth in any of Variations 11-13 wherein the thermal management system further comprises an exhaust heat recovery system and wherein the coolant circuit routes coolant through the exhaust heat recovery system from the engine.

Variation 15 may include a method as set forth in any of Variations 11-14 wherein the thermal management system further comprises an engine oil heat exchanger and wherein the coolant circuit routes coolant through the engine oil heat exchanger from the engine.

Variation 16 may include a method as set forth in any of Variations 11-15 wherein the thermal management system further comprises a transmission oil heat exchanger and wherein the coolant circuit routes coolant through the transmission oil heat exchanger from the engine.

Variation 17 may include a method as set forth in any of Variations 11-16 wherein the engine further comprises a turbocharger.

Variation 18 may include a method as set forth in any of Variations 11-17 wherein the thermal management system further comprises a radiator and wherein the coolant circuit routes coolant through the radiator from the engine.

Variation 19 may include a method as set forth in any of Variations 12-18 wherein the ECU controls the thermostat and/or coolant control valve to control coolant circuit outlet flow from the engine

Variation 20 may include a method as set forth in any of Variations 11-19 wherein the engine is an internal combustion engine, an external combustion engine, an electric motor, or a hybrid engine.

Variation 21 may include a method, and/or a product as set forth in any of Variations 1-20 wherein the thermal management system further includes sensors that acquire data regarding temperatures of fluids/components, pressures, speeds of fluids or components, and submits that data to the ECU for optimization of the system to minimize fuel usage.

Variation 22 may include a method, and/or a product as set forth in any of Variations 1-21 wherein the turbocharger includes an intercooler.

Variation 23 may include a method, and/or a product as set forth in any of Variations 1-22 wherein the turbocharger provides additional heat to the coolant.

Variation 24 may include a method, and/or a product as set forth in any of Variations 1-23 wherein the thermal management system further includes a heat exchanger for axle oil that may be used to transfer heat to and from the coolant from axle oil and may further include an axle oil heat exchanger valve.

Variation 25 may include a method, and/or a product as set forth in any of Variations 1-24 wherein the valves of the thermal management system are at least one of ball valves, butterfly valves, ceramic disc valves, check valves, choke valves, diaphragm valves, gate valves, globe valves, knife valves, needle valves, pinch valves, piston valves, plug valves, poppet valves, spool valves, thermal expansion valves, pressure reducing valves, or combinations thereof.

Variation 26 may include a method, and/or a product as set forth in any of Variations 1-25 the heat exchangers of the thermal management system are at least one of double pipe, radiator, shell and tube, plate heat, plate and shell, adiabatic wheel, plate fin, pillow plate, fluid heat, dynamic scraped surface, or phase-change heat exchanger, or combinations thereof.

Variation 26 may include a method, and/or a product as set forth in any of Variations 1-25 wherein the valves of the thermal management system may be a proportioning type valve which may allow full, partial, or no flow to the exit lines of the particular valve.

Variation 27 may include a method, and/or a product as set forth in any of Variations 1-26 wherein the ECU controls the change of flow of coolant through operation of the thermal management system valves.

Variation 28 may include a method, and/or a product as set forth in any of Variations 1-27 wherein the pump is kept off by the ECU and the engine is used to heat up coolant and oil within the engine block.

Variation 29 may include a method, and/or a product as set forth in any of Variations 1-28 wherein the ECU routes coolant through the cabin heater, EHRS, and transmission oil heat exchanger at a ratio of about 0.35/0.45/0.3.

Variation 30 may include a method, and/or a product as set forth in any of Variations 1-29 wherein engine oil heat exchanger valve routes coolant to the engine oil heat exchanger or to bypass the engine oil heat exchanger at a ratio of about 0.25/0.75 Variation 31 may include a method, and/or a product as set forth in any of Variations 1-30 wherein the thermostat includes the coolant control valve as a multi-functional valve.

The above description of select examples of the invention is merely exemplary in nature and, thus, variations or variants thereof are not to be regarded as a departure from the spirit and scope of the invention.

What is claimed is:

1. A product comprising: a thermal management system comprising:
an engine and a coolant system comprising a coolant circuit and a coolant pump wherein the coolant pump is operated by an electronic control unit that operates independently of the engine, and wherein the electronic control unit is constructed and arranged to operate the coolant pump at a higher speed than the engine speed multiplied by pulley ratio during engine warm up.

2. A product as set forth in claim 1 wherein the thermal management system further comprises a thermostat and/or coolant control valves.

3. A product as set forth in claim 1 wherein the thermal management system further comprises a cabin heater and wherein the coolant circuit routes coolant through the cabin heater from the engine.

4. A product as set forth in claim 1 wherein the thermal management system further comprises an exhaust heat recovery system and wherein the coolant circuit routes coolant through the exhaust heat recovery system from the engine.

5. A product as set forth in claim 1 wherein the thermal management system further comprises an engine oil heat exchanger and wherein the coolant circuit routes coolant through the engine oil heat exchanger from the engine.

6. A product as set forth in claim 1 wherein the thermal management system further comprises a transmission oil heat exchanger and wherein the coolant circuit routes coolant through the transmission oil heat exchanger from the engine.

7. A product as set forth in claim 1 wherein the engine further comprises a turbocharger.

8. A product as set forth in claim 1 wherein the thermal management system further comprises a radiator and wherein the coolant circuit routes coolant through the radiator from the engine when the thermostat is open.

9. A product as set forth in claim 2 wherein the electronic control unit controls the thermostat and/or coolant control valve to control coolant circuit outlet flow from the engine.

10. A product as set forth in claim 1 wherein the pump is a dual mode coolant pump, or electrical pump, or variable displacement pump.

11. A method comprising: providing a thermal management system comprising: an engine and a coolant system comprising a coolant circuit and a coolant pump wherein the coolant pump is operated by an electronic control unit that operates independently of the engine; and
operating the thermal management system during engine warm up wherein the coolant pump speed is higher than engine speed multiplied by pulley ratio.

12. A method as set forth in claim 11 wherein the thermal management system further comprises a thermostat and/or coolant control valves.

13. A method as set forth in claim 11 wherein the thermal management system further comprises a cabin heater and wherein the coolant circuit routes coolant through the cabin heater from the engine.

14. A method as set forth in claim 11 wherein the thermal management system further comprises an exhaust heat recovery system and wherein the coolant circuit routes coolant through the exhaust heat recovery system from the engine.

15. A method as set forth in claim 11 wherein the thermal management system further comprises an engine oil heat exchanger and wherein the coolant circuit routes coolant through the engine oil heat exchanger from the engine.

16. A method as set forth in claim 11 wherein the thermal management system further comprises a transmission oil heat exchanger and wherein the coolant circuit routes coolant through the transmission oil heat exchanger from the engine.

17. A method as set forth in claim 11 wherein the engine further comprises a turbocharger.

18. A method as set forth in claim 11 wherein the thermal management system further comprises a radiator and wherein the coolant circuit routes coolant through the radiator from the engine.

19. A method as set forth in claim 12 wherein the electronic control unit controls the thermostat and/or coolant control valves to control coolant circuit outlet flow from the engine.

20. A method as set forth in claim 11 wherein the pump is a dual mode coolant pump, or electrical pump, or variable displacement pump.
